(19) United States
(12) Patent Application Publication
(10) Pub. No.: US 2010/0237174 A1
(43) Pub. Date: Sep. 23, 2010

(54) FUEL INJECTOR

(75) Inventors: Ryutaro Oomori, Aichi-gun (JP); Noritsugu Kato, Okazaki-city (JP); Toyoji Nishiwaki, Anjo-city (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); NIPPON SOKEN, INC., Nishio-city (JP)

(21) Appl. No.: 12/728,421

(22) Filed: Mar. 22, 2010

(30) Foreign Application Priority Data
Mar. 23, 2009 (JP) 2009-70788
Jan. 12, 2010 (JP) 2010-004233

(51) Int. Cl. F02M 61/00

(52) U.S. Cl. 239/533.12

(57) ABSTRACT

A fuel injector has a plurality of fuel injection ports including first injection ports and second injection ports. Injection-port axes of the first injection ports extend to a first space in a combustion chamber. Injection-port axes of the second injection ports extend to a second space in a combustion chamber. An interval of the injection-port axes between adjacent first injection ports is shorter than an interval of the injection-port axes between the first injection port and the second injection port which are adjacent to each other.

### CROSS-REFERENCE TO RELATED APPLICATION

This application is based on Japanese Patent Applications No. 2009-70788 filed on Mar. 23, 2009 and No. 2010-004233 filed on Jan. 12, 2010, the disclosures of which are incorporated herein by reference.

### FIELD OF THE INVENTION

The present invention relates to a fuel injector which directly injects fuel into a cylinder of an internal combustion engine.

### BACKGROUND OF THE INVENTION

As shown in JP-2005-98117A, a fuel injector for direct injection is well known. Such a fuel injector is mounted on an internal combustion engine in such a manner that its injection portion is arranged at a periphery of a ceiling wall which defines a combustion chamber along with the other parts. The injection portion has a plurality of injection ports from which the fuel is radially sprayed into the combustion chamber. The fuel spray evenly spreads in the combustion chamber to generate air-fuel mixture which is suitable for a homogeneous combustion.

The combustion chamber is defined by the ceiling wall, a cylindrical inner wall of a cylinder, and an upper surface of a piston. A distance from the injection portion to the cylindrical inner wall close to the upper wall is shorter than a distance from the injection portion to the cylindrical inner wall close to the upper surface of the piston. Further, in order to make air-fuel mixture suitable for the homogeneous combustion, it is preferable that the fuel is injected from a plurality of ports of the injection portion and the fuel spray does not reach the cylindrical inner wall opposed to the injection portion. If the fuel spray reaches the cylindrical inner wall of the cylinder, the fuel adheres thereon, which may deteriorate an atomization of the fuel to cause an incomplete combustion in the combustion chamber.

In the fuel injector disclosed in the JP-2005-98117A, all of the fuel spray length (fuel spray travel) should be agreed with the shortest length from the injection portion to the cylindrical inner wall opposite to the injection portion in order that no fuel spray reaches the cylinder wall. However, if all of the fuel spray length is agreed with the shortest length, the fuel spray does not spread evenly in the combustion chamber, as shown in FIG. 2 of JP-2005-98117A. It is hard to make the air-fuel mixture suitable for the homogeneous combustion.

### SUMMARY OF THE INVENTION

The present invention is made in view of the above matters, and it is an object of the present invention to provide a fuel injector capable of making an air-fuel mixture suitable for a homogeneous combustion.

According to the present invention, a fuel injector has a plurality of injection ports through which fuel is injected into the combustion chamber and a valve member opening/closing the injection ports. The injection ports are arranged on a virtual circle around a center axis of the fuel injector. The injection ports include at least two first injection ports of which injection-port axes extend toward a first space in the combustion chamber. Further, the injection ports include at least one second injection port of which injection-port axis extends toward a second space in the combustion chamber. A first interval of the injection-port axes between the first injection ports which are adjacent to each other on the virtual circle is shorter than a second interval of the injection-port axes between the first injection port and the second injection port which are adjacent to each other on the virtual circle.

Fuel sprays injected from the first injection port and the second injection port reach the first space and the second space, so that the fuel sprays evenly spread in the combustion chamber to generate air-fuel mixture which is suitable for a homogeneous combustion.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 is a schematic view showing a direct injection gasoline engine on which a fuel injector is mounted, according to a first embodiment;

FIG. 2 is a cross-sectional view showing the fuel injector according to the first embodiment;

FIG. 3 is a plain view showing an arrangement of injection ports, when viewed from an interior of the fuel injector according to a first embodiment;

FIG. 4 is a perspective view showing fuel sprays injected from each injection port;

FIG. 5 is a graph showing a relationship between an interspace angle and a length of fuel spray;

FIG. 6 is a schematic view showing fuel sprays injected from the fuel injector mounted on the direct injection gasoline engine according to the first embodiment;

FIG. 7 is a plain view showing an arrangement of injection ports, when viewed from an interior of the fuel injector according to a second embodiment;

FIG. 8 shows a relationship between a particle diameter of the fuel spray and the interspace angle;

FIG. 9 is a plain view showing an arrangement of injection ports, when viewed from an interior of the fuel injector according to a third embodiment;

FIG. 10 is a plain view showing an arrangement of injection ports, when viewed from an interior of the fuel injector according to a fourth embodiment;

FIG. 11 is a schematic view showing fuel sprays injected from the fuel injector mounted on the direct injection gasoline engine according to the fourth embodiment;

FIG. 12 is a plain view showing an arrangement of injection ports, when viewed from an interior of the fuel injector according to a fifth embodiment;

FIG. 13 is a plain view showing an arrangement of injection ports, when viewed from an interior of the fuel injector according to a sixth embodiment;

FIG. 14 is a schematic view showing fuel sprays injected from the fuel injector mounted on the direct injection gasoline engine according to the sixth embodiment;

FIG. 15 is a plain view showing an arrangement of injection ports, when viewed from an interior of the fuel injector according to a seventh embodiment;

FIG. 16 is a schematic view showing fuel sprays injected from the fuel injector mounted on the direct injection gasoline engine according to the seventh embodiment;

FIG. 17 is a plain view showing an arrangement of injection ports, when viewed from an interior of the fuel injector according to an eighth embodiment; and

FIG. 18 is a schematic view showing fuel sprays injected from the fuel injector mounted on the direct injection gasoline engine according to the eighth embodiment.

### DETAILED DESCRIPTION OF EMBODIMENTS

Multiple embodiments of the present invention will be described with reference to accompanying drawings. In each embodiment, the same parts and the components are indicated with the same reference numeral and the same description will not be reiterated.

### First Embodiment

### (Overall Structure)

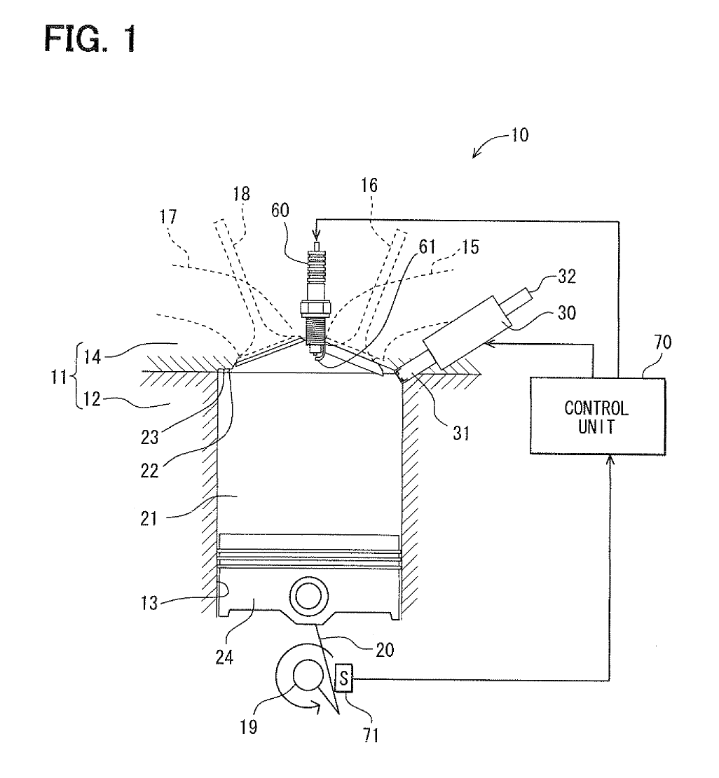

FIG. 1 is a schematic view showing a direct injection gasoline engine 10 on which a fuel injector 30 is mounted, according to a first embodiment. An overall structure of the gasoline engine 10 will be described in detail hereinafter.

The engine 10 is an inline four-cylinder engine. In FIG. 1, one of the cylinders is shown. The other cylinders have the same structure.

The engine 10 is comprised of an engine body 11, a piston 24, a fuel injector 30, a spark plug 60, and the like. An operation of the engine 10 is controlled by a control unit 70.

The engine body 11 is comprised of a cylinder block 12 and a cylinder head 14.

The cylinder block 12 is made of metallic material, such as aluminum and casting iron. The cylinder block 12 defines a cylinder 13 therein. An upper end of the cylinder 13 is opened at an upper surface of the cylinder block 12. The cylinder head 14 is provided on the cylinder block 12 to cover the upper end of the cylinder 13. A crank case (not shown) supporting a crankshaft 19 is provided under the cylinder block 12.

The cylinder head 14 is made of metallic material such as aluminum and casting iron. The cylinder head 14 has a ceiling wall 22 which closes the upper end of the cylinder 13. Further, the cylinder head 14 has an intake passage 15 and an exhaust passage 17 therein.

The intake passage 15 introduces fresh air into the combustion chamber 21. In FIG. 1, the intake passage 15 is illustrated by broken lines. The intake passage 15 is opened at the ceiling wall 22. The intake passage 15 extends toward the spark plug 60 to communicate with the combustion chamber 21. An intake valve 16 opens/closes the intake passage 15. The intake valve 16 is driven by a camshaft (not shown) which rotates along with the crankshaft 19. During an intake stroke of the engine 10, the intake valve 16 opens the intake passage 15. During a compression stroke, a power stroke, and an exhaust stroke, the intake valve 16 closes the intake passage 15.

When the intake valve 16 moves downward to open the intake passage 15, the fresh air is introduced into the combustion chamber 21. An intake air flow rate to be supplied to the combustion chamber 21 is adjusted by a throttle valve (not shown) disposed upstream in the intake passage 15. When the intake valve moves upward to close the intake passage 15, the fresh air supply is stopped.

The exhaust passage 17 introduces exhaust gas to the outside of the engine 10. In FIG. 1, the exhaust passage 17 is illustrated by broken lines. The exhaust passage 17 is opened at the ceiling wall 22. The exhaust passage 17 extends toward the spark plug 60 to communicate with the combustion chamber 21. An exhaust valve 18 opens/closes the exhaust passage 17. The exhaust valve 18 is driven by an exhaust camshaft (not shown) which rotates along with the crankshaft 19. During the exhaust stroke of the engine 10, the exhaust valve 18 opens the exhaust passage 17. During the intake stroke, the compression stroke, and the power stroke, the exhaust valve 18 closes the exhaust passage 17.

When the exhaust valve 18 moves downward to open the exhaust passage 17, the exhaust gas is discharged from the combustion chamber 21 to outside of the engine 10. When the exhaust valve 18 moves upward to close the exhaust passage 17, the exhaust gas discharge is stopped.

It should be noted that the opening periods of the intake valve 16 and the exhaust valve 18 can be overlapped with each other in order to improve a driving efficiency of the engine 10.

The piston 24 reciprocates in the cylinder 13 along a center axis of the cylinder 13. A connecting rod 20 connects the piston 24 and the crankshaft 19. A reciprocating motion of the piston 24 is converted into a rotating motion of the crankshaft 19.

The fuel injector 30 injects a specified quantity of fuel into the combustion chamber 21 directly according to a driving condition of the engine 10. The fuel injector 30 has an injection portion 31 at its tip end portion. As shown in FIG. 1, the fuel injector 30 is mounted in the cylinder head 14 in such a manner that the injection portion 31 is positioned at a periphery portion 23 of the ceiling wall 22. Further, the fuel injector 30 has a fuel inlet port 32 at its base end portion. The fuel inlet port 32 is fluidly connected to a fuel pipe (not shown) through which pressurized fuel is supplied to the fuel inlet port 32.

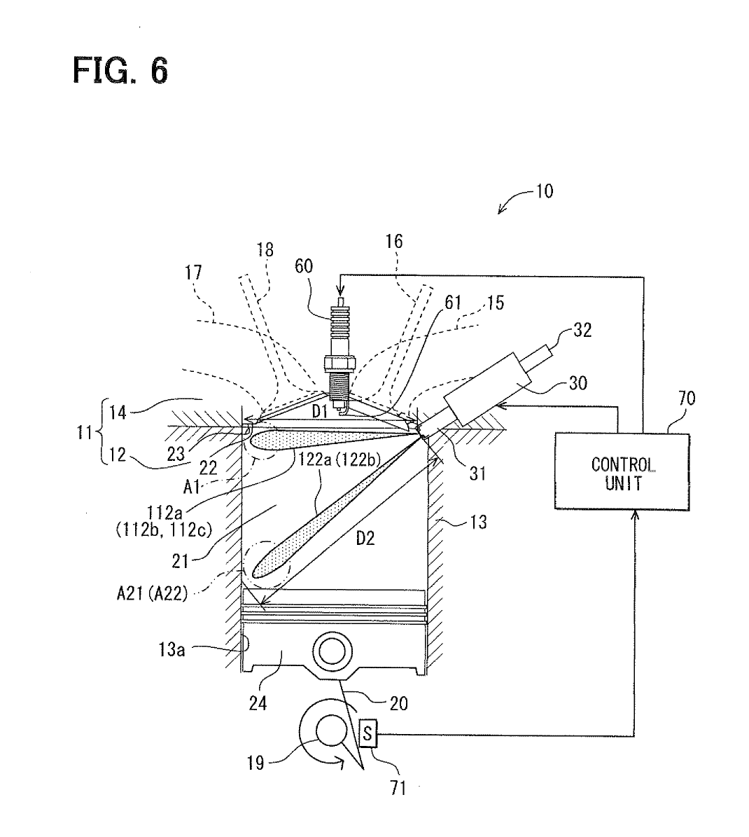

The fuel injector 30 receives a control pulse signal from the control unit 70. When the control pulse signal is ON, the fuel injector 30 injects the fuel. A plurality of fuel sprays are formed in the combustion chamber 21, as shown in FIG. 6. The fuel spray is comprised of fuel particles of which diameters are small. These fuel particles are atomized by the intake air in the combustion chamber 21 so that air-fuel mixture is produced in the combustion chamber 21.

The spark plug 60 is mounted in the cylinder head 14 in such a manner that its spark portion 61 is positioned at a center of the ceiling wall 22. The spark plug 60 is positioned between the intake passage 15 and the exhaust passage 17. When the spark plug 60 receives a control pulse signal from the control unit 70, the spark portion 61 generates a spark to ignite the air-fuel mixture in the combustion chamber 21.

The control unit 70 controls the fuel injector 30, the spark plug 60 and the like. The control unit 70 is comprised of a central processing unit (CPU), a read only memory (ROM), a random access memory (RAM), an input-output unit, and driving circuits for driving the fuel injector 30 and the spark plug 60. The ROM of the control unit 70 stores control programs which the CPU executes.

The control unit 70 receives detection signals from a crank position sensor 71 detecting a crank speed and a crank angle of the crankshaft 19, a cam position sensor (not shown) detecting a cam angle of the camshaft, a throttle position senor detecting a throttle position, and the like.

The control unit 70 generates command signals for driving the fuel injector 30 and the spark plug 60 based on the programs and the data stored in the ROM and the above detection signals. Further, the CPU sends the command signals to the driving circuits through the input-output unit. The driving circuits generate the control pulses based on the command signals and send these control pulses to the fuel injector 30 and the spark plug 60 at a specified timing.

When an engine load or an engine speed is low and a target torque is less than a specified value, the control unit 70 determines that a stratified combustion should be performed. Meanwhile, when the engine load or the engine speed is high and the target torque is not less than the specified value, the control unit 70 determines that a homogeneous combustion should be performed.

### (Specific Structure of Fuel Injector)

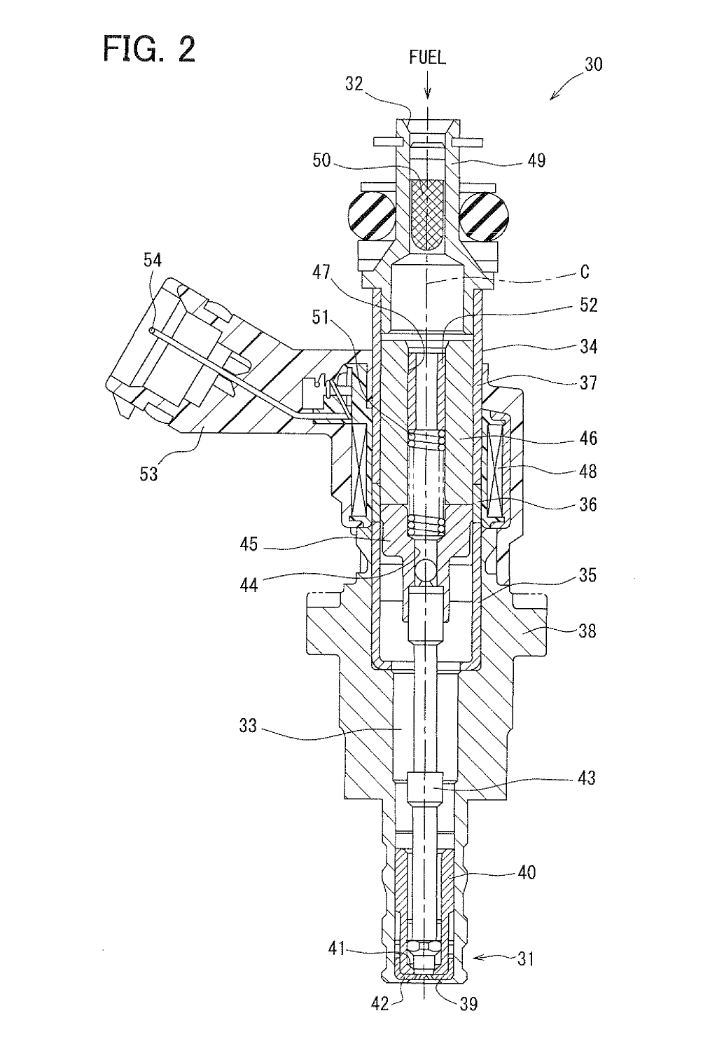

Referring to FIG. 2, specific structure of the fuel injector 30 will be described in detail hereinafter.

As described above, the fuel injector 30 has the injection portion 31 and the fuel inlet port 32. The fuel injector 30 has a fuel passage 33 which extends along a center axis “C” of a valve body 40 to fluidly connect the fuel inlet port 32 and the injection portion 31. The fuel introduced from the fuel inlet port 32 flows through the fuel passage 33 toward the injection portion 31.

The fuel injector 30 is comprised of a pipe 34, a valve housing 38, the valve body 40, an injection port member 42, a needle valve 43, a movable core 45, a stationary core 46, and a coil 48.

The pipe 34 is comprised of a first magnetic portion 35, a non-magnetic portion 36, and a second magnetic portion 37. The non-magnetic portion 36 prevents a magnetic short circuit. The first and the second magnetic portion 35, 36 and the non-magnetic portion 36 are connected to each other by welding. The pipe 34 defines a part of the fuel passage 33 therein.

An inlet member 49 having the fuel inlet port 32 is provided at a base end portion of the second magnetic portion 37. A filter 50 is provided in the inlet member 49 to capture foreign matters contained in the fuel introduced from the fuel inlet port 32. A cylindrical valve housing 38 is provided at a tip end portion of the first magnetic portion 35.

Also, the valve housing 38 defines another part of the fuel passage 33 therein. A valve body 40 is provided in the valve housing 38.

The valve body 40 has cylindrical shape and defines another part of the fuel passage 33 therein. An inner wall surface of the valve body 40 includes a conical inner surface which corresponds to a valve seat 41 on which a needle valve 43 sits.

The injection port member 42 is cup-shaped and disposed in a tip end portion of the valve body 40. A side wall of the injection port member 42 is sandwiched between the valve housing 38 and the valve body 40. The valve housing 38 has an opening 39 at its tip end. A bottom surface of the injection port member 42 is exposed outside through the opening 39.

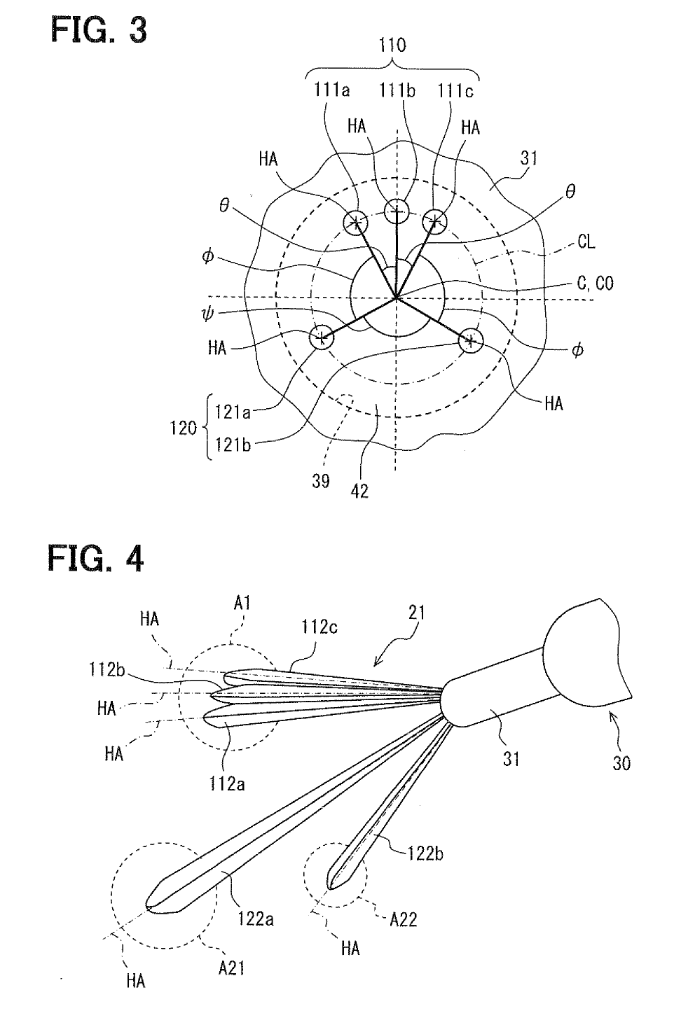

FIG. 3 shows an arrangement of a plurality of injection ports 111a, 111b, 111c, 121a, 121b which are formed in the injection port member 42, viewed from interior. FIG. 4 shows fuel sprays injected from the injection ports 111a, 111b, 111c, 121a, 121b.

In the present embodiment, five injection ports 111a, 111b, 111c, 121a, 121b are formed in the injection port member 42. Each of the injection ports 111a, 111b, 111c, 121a, 121b is arranged on a virtual circle “CL” around the center axis “C” of the valve body 40 in such a manner as to penetrate the injection port member 42. An axis “HA” of each injection port 111a, 111b, 111c, 121a, 121b is inclined relative to the center axis “C” of the valve body 40 in such a manner as to diverge. A diameter of each injection port 111a, 111b, 111c, 121a, 121b is substantially equal to each other. However, it is not always needed that the axis “HA” diverges and the diameter of each injection port 111a, 111b, 111c, 121a, 121b is equal to each other.

Five injection ports 111a, 111b, 111c, 121a, 121b can be grouped into an injection port group 110 and an injection port group 120. The injection port group 110 is comprised of three injection port 111a, 111b, 111c which are adjacent to each other on the virtual circle “CL”.

As shown in FIG. 4, the axis “HA” of each injection port 111a, 111b, 111c extends toward a space “A1” in the combustion chamber 21, which is illustrated by a broken line. An interval of the axis “HA” between adjacent injection ports 111a and 111b is defined in such a manner that the fuel sprays injected from each injection port 111a, 111b interfere with each other so that the length of each fuel spray (fuel spray travel) is varied. Also, an interval of the axis “HA” between adjacent injection ports 111b and 111c is defined in such a manner that the fuel sprays injected from each injection port 111b, 111c interfere with each other so that the length of each fuel spray (fuel spray travel) is varied.

The injection port group 120 is comprised of the injection ports 121a and 121b which are on the virtual circle “CL”.

The axis “HA” of the injection port 121a in the injection port group 120 extends to a space “A21” illustrated by a broken line in FIG. 4. An interval of the axis “HA” between the injection port 111a in the injection port group 110 and the adjacent injection port 121a in the injection port group 120 is defined in such a manner that the fuel sprays injected from each injection port 111a and 121a do not interfere with each other so that the length of each fuel spray (fuel spray travel) is not varied.

The axis “HA” of the injection port 121b in the injection port group 120 extends to a space “A22” illustrated by a broken line in FIG. 4. An interval of the axis “HA” between the injection port 111c in the injection port group 110 and the adjacent injection port 121b in the injection port group 120 is defined in such a manner that the fuel sprays injected from each injection port 111c and 121b do not interfere with each other so that the length of each fuel spray (fuel spray travel) is not varied. Further, in the injection port group 120, an interval of the axis “HA” between adjacent injection ports 121a and 121b is defined in such a manner that the fuel sprays injected from each injection port 121a, 121b do not interfere with each other so that the length of each fuel spray (fuel spray travel) is not varied.

These injection ports 111a, 111b, 111c, 121a, 121b are opened/closed by the needle valve 43.

As shown in FIG. 2, the needle valve 43, the movable core 45, the stationary core 46, a spring 51, and an adjusting pipe 52 are disposed in the fuel passage 33. The needle valve 43 is coaxially disposed in the fuel passage 33 to reciprocate along an axis line of the fuel passage 33. A base end of the needle valve 43 is connected with the movable core 45 by welding. The movable core 45 reciprocates in the fuel passage 33 along with the needle valve 43. The movable core 45 has a communication passage 44 therein, which fluidly connects a base end portion of the movable core 45 and a peripheral portion of the movable core 45.

The stationary core 46 is disposed in the pipe 34 in such a manner as to confront the movable core 45. The stationary core 46 is welded to an inner surface of the pipe 34. When the needle valve 43 seats on the valve seat 41, a specified clearance gap is formed between the stationary core 46 and the movable core 45.

The stationary core 46 has a vertical hole 47 which fluidly connects both ends thereof. The fuel introduced from the fuel inlet port 32 flows through the vertical hole 47 toward the communication passage 44.

The spring 51 and the adjusting pipe 52 are accommodated in the vertical hole 47, The spring 51 biases the needle valve 43 toward the valve seat 41. The adjusting pipe 52 supports one end of the spring 51.

The adjusting pipe 52 is press-inserted into the vertical hole 47. A biasing force of the spring 51 is adjusted according to a longitudinal position of the adjusting pipe 52. The adjusting pipe 52 is shaped so as not to interrupt a fuel flow in the vertical hole 47.

A coil 48 is winded around the pipe 34 through a spool made of resin. Both ends of the coil 48 are electrically connected with a terminal 54. When the coil is energized, a magnetic field is generated. The terminal 54 is insert-molded in the connector 53 made of resin.

When the coil 48 is energized, a magnetic attracting force is generated to attract the movable core 45 to the stationary core 46. When the magnetic attracting force becomes larger than the biasing force of the spring 51, the movable core 45 and the needle valve 43 are attracted to the stationary core 46. The needle valve 43 moves away from the valve seat 41 to open the injection ports 111a, 111b, 111c, 121a, 121b, whereby the fuel is injected into the combustion chamber 21 therefrom.

When the coil 48 is deenergized, the magnetic field is disappeared. The movable core 45 moves toward the injection portion 31, so that the needle valve 43 sits on the valve seat 41 to close the injection ports 111a, 111b, 111c, 121a, 121b.

### (Arrangement of Injection Ports)

Referring to FIGS. 3 to 6, an arrangement of the injection ports 111a, 111b, 111c, 121a, 121b will be described in detail, hereinafter.

An interaction between adjacent two fuel sprays which are respectively injected from adjacent two injection ports on the virtual circle “CL” will be described. An angle between axes “HA” of adjacent two injection ports around the center axis “C” of the valve body 40 is referred to as an interspace angle. The center axis “C” crosses a center point “CO” of the virtual circle “CL”.

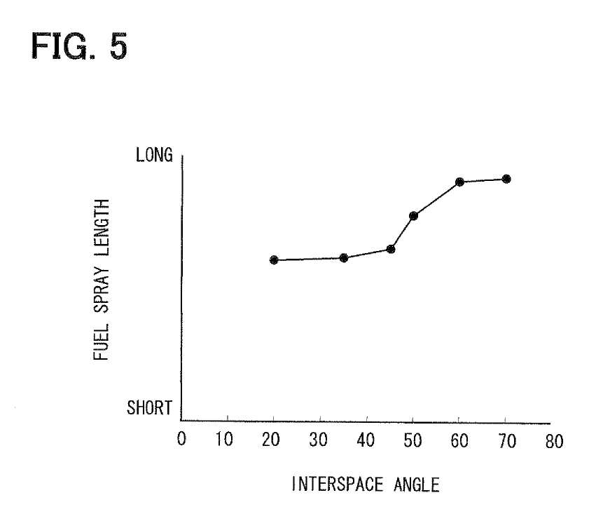

FIG. 5 shows a relationship between a variation in the fuel spray length and the interspace angle, wherein the interspace angle is varied from 20° to 70°. As shown in FIG. 5, in a range where the interspace angle is from 35° to 60°, as the interspace angle is smaller, the fuel spray length (fuel spray travel) becomes shorter. According to the inventors' research, it becomes apparent that the above phenomenon is caused by an interaction between two functions.

In the first function, as the interspace angel becomes smaller, the fuel sprays injected from each injection port come close to each other. That is, each of the fuel spray is attracted to each other by Coanda effect. The Coanda effect is a phenomenon where the pressure between adjacent fuel sprays is decreased to be negative pressure so that each fuel spray is attracted to each other. Each fuel spray is curved to be converged. A velocity vector of each fuel spray in its fuel spray axis is diverged in a radial direction of the fuel spray. An energy by which the fuel spray travels straight is decreased, so that a penetration force of each fuel spray is decreased. The Coanda effect is more increased as the interspace angle becomes smaller.

In the second function, as an interval between adjacent two axes “HA” becomes shorter, a fuel flow passage area upstream of the injection ports is decreased so that fuel quantity flowing into each injection port is decreased. Thus, according to the interaction between the first function and the second function, the fuel spray length becomes shorter as the interspace angle is smaller in a range of 35° to 60°. Meanwhile, in a case that the interspace angle is larger than 60°, the Coanda effect does not arise between adjacent fuel sprays and the fuel quantity flowing into each injection port is kept enough. Thus, the fuel spray length (fuel spray travel) is specific to each fuel injection port.

As described above, the fuel spray length can be adjusted by varying the interspace angle in a range of 35° to 60°. In a case that the interspace angle is less than 35°, the fuel spray length is substantially constant as shown in FIG. 5 and a precise drilling of the injection port can be hardly obtained. Thus, the interspace angle is not less than 35°.

According to the first embodiment, as shown in FIG. 3, the interspace angle φ between the injection port group 110 and the injection port group 120 is larger than 60°. That is, the interspace angle φ between the injection ports 111a and 121a and the interspace angle φ between the injection ports 111c and 121b are larger than 60°. In the injection port group 120, the interspace angle ψ between adjacent two injection ports 121a and 121b is larger than 60°. Therefore, the fuel spray 122a injected from the injection port 121a and the fuel spray 122b injected from the injection port 121b do not interfere with each other. The fuel sprays 122a and 122b reach the space “A21” and the space “A22” respectively. The fuel spray lengths of the fuel sprays 122a and 122b are specific.

In the injection port group 110, the interspace angles θ between the injection ports 111a and 111b and between the injection ports 111b and 111c are set to a specified value in a range of 35° to 60°. The intervals of the axes “HA” between the injection ports 111a and 111b and between the injection ports 111b and 111c is shorter than those between the injection ports 111a and 121a, between the injection ports 111c and 121b, and between the injection ports 121a and 121b. The fuel sprays 112a, 112b, 112c injected from the injection ports 111a, 111b, 111c interact with each other and reach the space “A1”. The lengths of the fuel sprays 112a, 112b, 112c is shorter than that of the fuel sprays 122a, 122b injected from the injection ports 121a, 121b.

### (Forming of Fuel Spray)

With respect to forming of fuel spray, it will be described in detail.

FIG. 6 shows the combustion chamber 21 of the engine 10 into which the fuel injector 30 injects the fuel. Especially, FIG. 6 shows a homogenous combustion in the combustion chamber 21. When the control unit 70 determines that the piston 24 is at a vicinity of the bottom dead center during the intake stroke, the control unit 70 drives the injector 30 to form fuel sprays 112a, 112b, 112c, 122a, 122b, as shown in FIGS. 4 and 6.

Specifically, the fuel sprays 112a, 112b, 112c injected from three injection ports 111a, 111b, 111c in the injection port group 110 are formed in such a manner as to reach the space “A1”, It should be noted that the space “A1” is defined at a vicinity of a cylindrical inner wall 13a of the cylinder 13, which is opposed to the injector 30. Further, the space “A1” is close to the ceiling wall 22

The fuel sprays 122a, 122b injected from the injection ports 121a, 121b extend to the space “A21” and the space “A22” respectively. The space “A21” and the space “A22” are defined at a vicinity of the cylindrical inner wall 13a of the cylinder 13, which are opposed to the injector 30 and are close to the piston 24 at the bottom dead center. In FIG. 6, the fuel sprays 122a and 112a are illustrated, The fuel spray 122b is formed behind the fuel spray 122a. The fuel sprays 112b, 112c are formed behind the fuel spray 112a.

In the first embodiment, the intervals of axes “HA”, which correspond to the interspace angles, are defined in such a manner that the fuel sprays 112a, 112b, 112c reach the space “A1” and the fuel sprays 122a, 122b reach the space “A21” and the space “A22” respectively. As shown in FIG. 6, a distance “D1” between the injection portion 31 and the space “A1” is different from a distance “D2” between the injection portion 31 and the spaces “A21”, “A22”. Especially, in the present embodiment, the distance “D2” is longer than the distance “D1”.

In a conventional injector, all of the fuel spray lengths (fuel spray travel) are equal to each other. In other words, the fuel spray does not reach a space corresponding to the spaces “A21”, “A22”. Thus, the fuel spray does not spread evenly in the combustion chamber 21, and it is hard to make the air-fuel mixture suitable for the homogeneous combustion.

According to the present embodiment, the intervals of the axes “HA” in the injection port group 110 (interspace angle θ) is made short, whereby the length of the fuel sprays 112a, 112b, 112c (fuel spray travel) can be made shorter than the original length specific to each injection port 111a, 111b, 111c. Thus, the fuel sprays having different lengths can be generated in the combustion chamber 21.

As described above, according to the fuel injector 30 of the first embodiment, even if the distance from the injection portion 31 to the inner side wall of the combustion chamber 21 is varied with respect to the injection direction of the fuel spray, the fuel spray can be equally spread in the combustion chamber 21, avoiding that the fuel spray reaches the inner side wall of the combustion chamber 21. Thus, the fuel injector 30 can inject the air-fuel mixture suitable for the homogeneous combustion.

In the above first embodiment, the valve housing 38, the valve body 40, and the injection port member 42 correspond to “body portion”, and the needle valve 43 corresponds to “valve member” of the present invention. Further, the injection ports 111a, 111b, 111c correspond to “first injection ports”, and each of the injection ports 121a, 121b correspond to “second injection port”. The space “A1” corresponds to “first space”, and the second and the third space “A21”, “A22” correspond to “second space” of the present invention.

### Second Embodiment

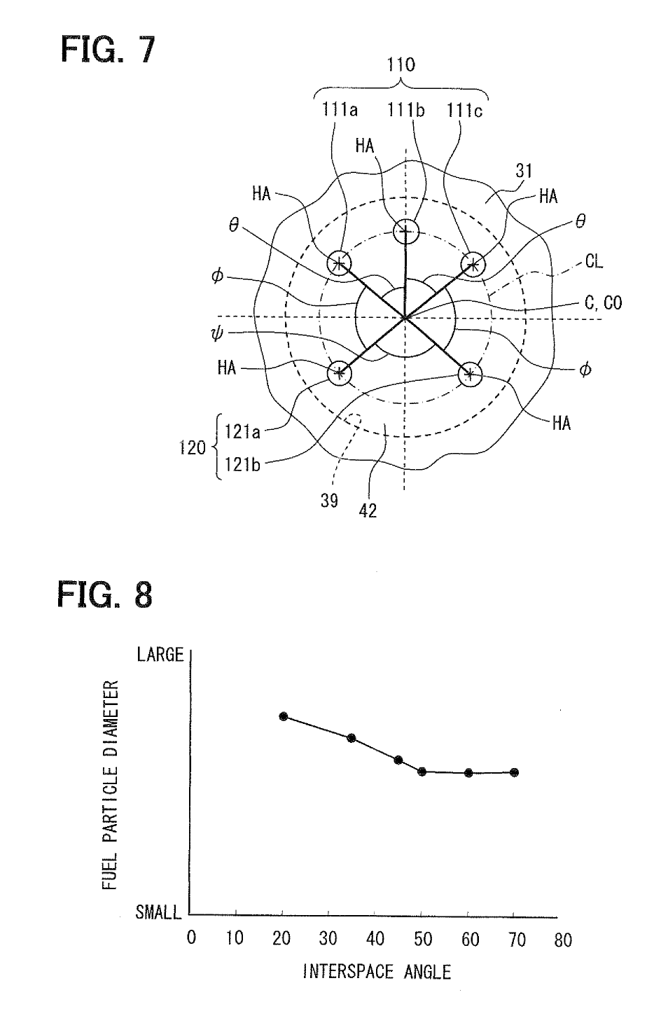

A second embodiment is a modification of the first embodiment. As shown in FIG. 7, an arrangement of the injection ports 111a, 111b, 111c in the injection port group 110 is different from that in the first embodiment. In the second and the successive embodiments, the same parts and components as those in the first embodiment are indicated with the same reference numerals and the same descriptions will not be reiterated.

FIG. 7 shows an arrangement of a plurality of injection ports 111a, 111b, 111c, 121a, 121b which are formed in the injection port member 42, viewed from interior. In the injection port group 110, the interspace angles θ between the injection ports 111a and 111b and between the injection ports 111b and 111c are set to a specified value in a range of 50° to 60°.

FIG. 8 shows a relationship between a variation in particle diameter of the fuel spray and the interspace angle, wherein the interspace angle is varied from 20° to 70°. In a range of interspace angle from 20° to 50°, as the interspace angle becomes larger, the particle diameter of the fuel spray becomes smaller. In a case that the interspace angle exceeds 50°, the particle diameter of the fuel spray becomes substantially constant.

As described in the first embodiment, in a range of the interspace angle from 35° to 60°, the Coanda effect is generated between adjacent fuel sprays. Thus, when the interspace angle is defined to a specific value within a range from 50° to 60°, the length of the fuel spray can be adjusted without increasing the particle diameter, so that the air-fuel mixture suitable for the homogeneous combustion can be advantageously obtained.

According to the second embodiment, the lengths of the fuel sprays 112a, 112b, 112c can be made shorter than those of the fuel sprays 122a, 122b, and the particle diameter can be decreased. The advantages described in the first embodiment can be enhanced.

The injection ports 111a, 111b, 111c of the second embodiment correspond to “first injection ports” of the present invention.

### Third Embodiment

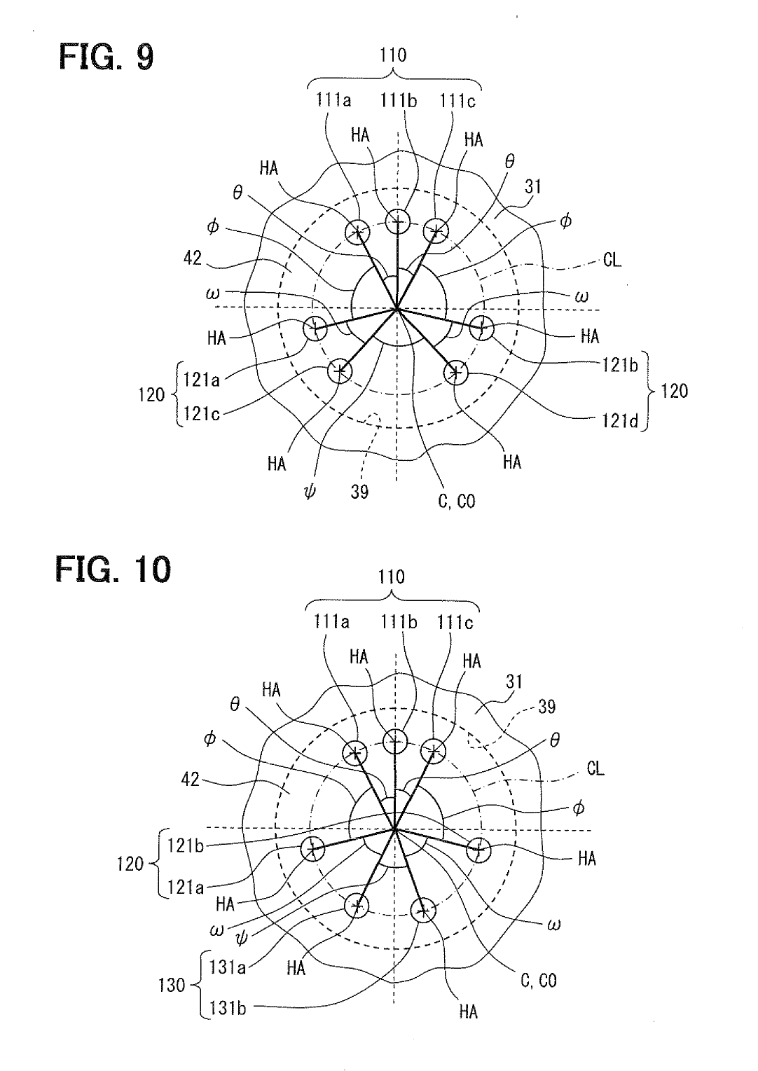

A third embodiment is a modification of the first embodiment. In the third embodiment shown in FIG. 9, injection ports 121c and 121d are added to the first embodiment.

FIG. 9 shows an arrangement of seven injection ports 111a, 111b, 111c, 121a, 121b, 121c, 121d which are formed in the injection port member 42, viewed from interior. The injection ports 121c, 121d are arranged on the virtual circle “CL”. An axis “HA” of each injection port 121c, 121d is inclined relative to the center axis “C” of the valve body 40 in such a manner as to diverge from the center axis “C”.

The injection port group 110 is comprised of three injection ports 111a, 111b, 111c, and the injection port group 120 is comprised of four injection ports 121a, 121b, 121c, 121d. The injection port 121a and the injection port 121c are adjacent to each other on the virtual circle “CL”, and the axes “HA” of these injection ports 121a, 121c extend to the space “A21”. The injection port 121b and the injection port 121d are adjacent to each other on the virtual circle “CL”, and the axes “HA” of these injection ports 121b, 121d extend to the space “A22”.

In the injection port group 120, the interspace angles ω between the injection ports 121a and 121c and between the injection ports 121b and 121d are set to a specified value in a range of 35° to 60°. It should be noted that the interspace angle ω is larger than the interspace angle θ between the injection ports 111a and 111b and between the injection ports 111b and 111c.

In the injection port group 120, the interspace angle ψ between adjacent two injection ports 121c and 121d is larger than 60°. The interspace angle φ between the injection ports 121a and 111a and between the injection ports 121b and 111c is larger than 60°.

The fuel sprays 112a, 112b, 112c injected from the injection ports 111a, 111b, 111c interact with each other and reach the space “A1”. The fuel sprays injected from the injection ports 121a, 121c reach the space “A21”, and the fuel sprays injected from the injection ports 121b, 121d reach the space “A22”. According to the third embodiment, by setting the interval of the axes “HA” in the injection port group 120 (interspace angle ω) to a specified value, the length of the fuel sprays (fuel spray travel) injected from the injection ports 121a, 121c, 121b, 121d can be adjusted.

The lengths of the fuel sprays 112a, 112b, 112c can be made shorter than those of the fuel sprays injected from the injection port group 120. The third embodiment has the substantially the same advantages as the first embodiment.

In the third embodiment, the injection ports 121a, 121b, 121c, 121d correspond to “second injection port” of the present invention.

### Fourth Embodiment

A fourth embodiment is a modification of the first embodiment. In the fourth embodiment shown in FIG. 10, injection ports 131a and 131b are added to the first embodiment. A characteristic configuration different from the first embodiment will be described below.

FIG. 10 shows an arrangement of seven injection ports 111a, 111b, 111c, 121a, 121b, 131a, 131b which are formed in the injection port member 42, viewed from interior. The injection ports 131a, 131b are arranged on the virtual circle “CL”. An axis “HA” of each injection port 131a, 131b is inclined relative to the center axis “C” of the valve body 40 in such a manner as to diverge from the center axis “C”.

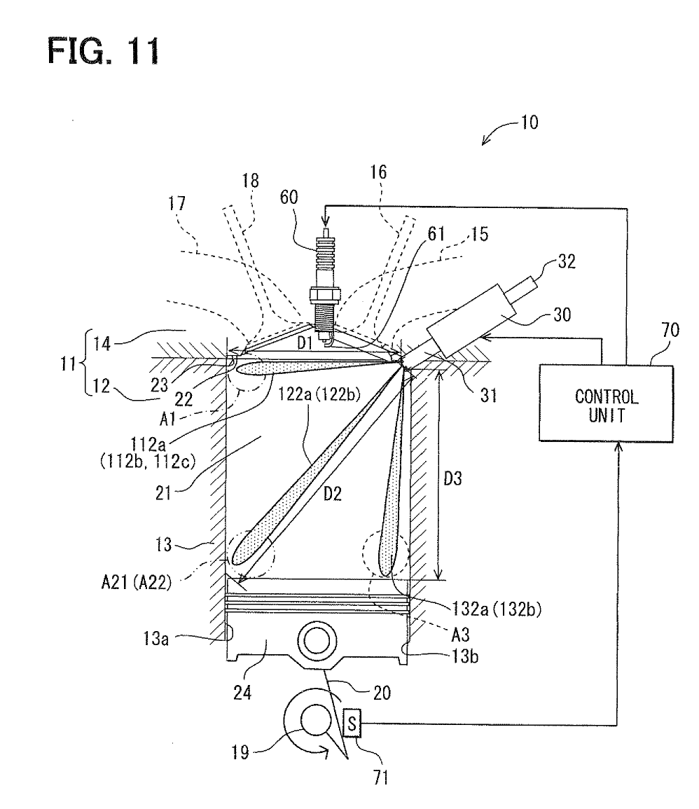

The injection port group 110 is comprised of three injection ports 111a, 111b, 111c, the injection port group 120 is comprised of two injection ports 121a, 121b, and the injection port group 130 is comprised of two injection ports 131a, 131b. The injection ports 131a, 131b are arranged between the injection ports 121a, 121b on the virtual circle “CL”, and the axes “HA” of these injection ports 131a, 131b extend to the space “A3”. The space “A3” illustrated by a broken line in FIG. 11 is defined at a vicinity of a cylindrical inner wall 13b of the cylinder 13, which is under the injector 30 and is close to the piston 24 at the bottom end center. Thus, according to the fourth embodiment, a distance “D3” from the injection portion 31 to the space “A3” is longer than the distance “D1” from the injection portion 31 to the space “A1” and is shorter than the distance “D2” from the injection portion 31 to the spaces “A21”, “A22”. That is, the fourth embodiment is applied to a long-stroke engine 10 in which a stroke of the piston 24 is longer than an inner diameter of the cylinder 13.

The fuel sprays 132a, 132b injected from the injection ports 131a, 131b reach the space “A3”. Since FIG. 11 is a cross-sectional view, only fuel sprays 132a, 112a, 122a are illustrated in FIG. 11. The fuel spray 132b is formed behind the fuel spray 132a.

In the injection port group 130, the interspace angles between the injection ports 131a and 131b is set to a specified value in a range of 50° to 60°.It should be noted that the interspace angle ψ is larger than the interspace angle θ between the injection ports 111a and 111b and between the injection ports 111b and 111c. The interval of the axes “HA” between the injection ports 131a and 131b is longer than those between the injection ports 111a and 111b and between the injection ports 111b and 111c.

In the injection port groups 120, 130, the interspace angle ω between the injection ports 131a and 121a and between the injection ports 131b and 121b are set to a specified value in a range of 35° to 60°. It should be noted that the interspace angle ω is larger than the interspace angles ψ and θ. The interval of the axes “HA” between the injection ports 131a and 121a and between the injection ports 131b and 121b are longer than those between the injection ports 131a and 131b, between the injection ports 111a and 111b, and between the injection ports 111b and 111c.

The fuel sprays 112a, 112b, 112c injected from the injection ports 111a, 111b, 111c interact with each other and reach the space “A1”. The fuel sprays 132a, 132b injected from the injection ports 131a, 131b interact with each other and reach the space “A3”. The fuel sprays 122a, 122b injected from the injection ports 121a, 121b interact with each other and reach the space “A21” and the space “A22” respectively. According to the fourth embodiment, by setting the interval of the axes “HA” of the injection port group 130 (interspace angle ω) to a specified value, the length of the fuel sprays 132a, 132b (fuel spray travel) can be adjusted.

The lengths of the fuel sprays 132a, 132b can be made shorter than those of the fuel sprays 122a, 122b injected from the injection port group 120. The lengths of the fuel sprays 132a, 132b can be made longer than those of the fuel sprays 112a, 112b, 112c. The fuel injector 30 according to the fourth embodiment is suitable for a long-stroke engine 10.

According to the fourth embodiment, the injection ports 111a, 111b, 111c, 131a, 131b correspond to “first injection ports” of the present invention. The space “A1” and the space “A3” correspond to “first space” of the present invention.

### Fifth Embodiment

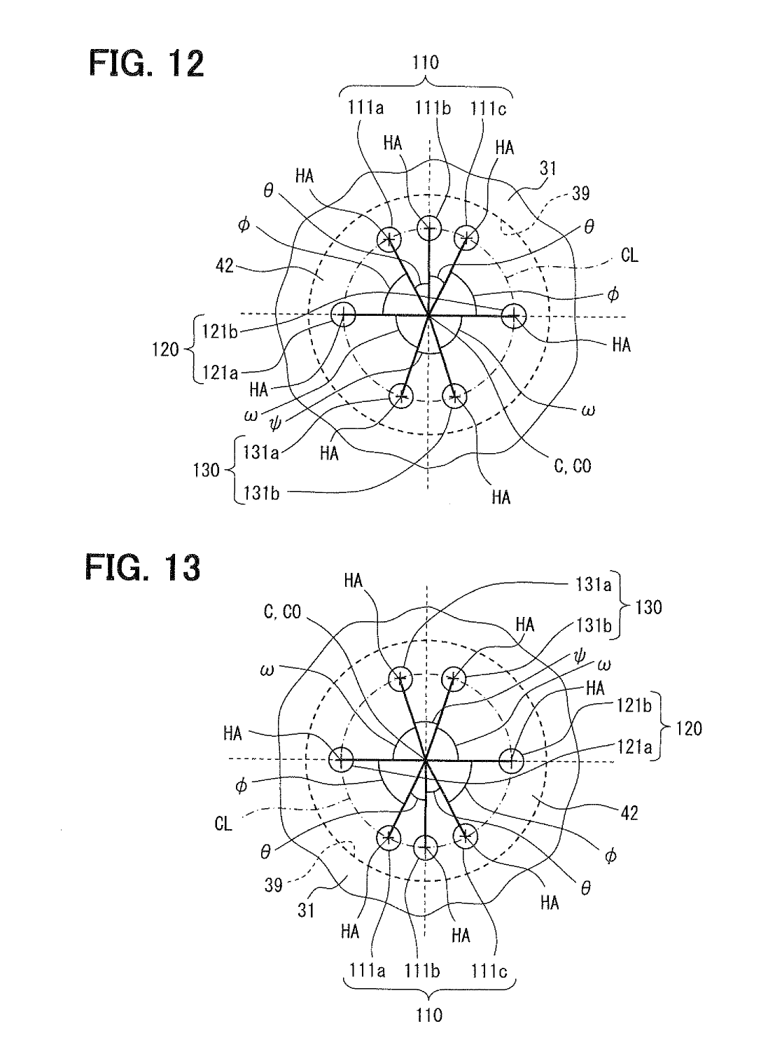

A fifth embodiment is a modification of the fourth embodiment. As shown in FIG. 12, an arrangement of the injection ports 121a, 121b in the injection port group 120 is different from that in the fourth embodiment. A characteristic configuration different from the fourth embodiment will be described below.

FIG. 12 shows an arrangement of seven injection ports 111a, 111b, 111c, 121a, 121b, 131a, 131b which are formed in the injection port member 42, viewed from interior. In the injection port group 110 and the injection port group 120, the interspace angles φ between the injection ports 121a and 111a and between the injection ports 121b and 111c are set to a specified value in a range of 50° to 60°.It should be noted that the interspace angle is larger than the interspace angle θ between the injection ports 111a and 111b and between the injection ports 111b and 111c. The interval of the axes “HA” between the injection ports 121a and 111a and between the injection ports 121b and the 111c is longer than those between the injection ports 111a and 111b and between the injection ports 111b and 111c.

The fuel sprays 122a, 122b injected from the injection ports 121a, 121b interact with each other and reach the space “A21” and the space “A22” respectively. The lengths of the fuel sprays 122a, 122b injected from the injection port group 120 can be made longer than those of the fuel sprays 112a, 112b, 112c injected from the injection port group 110 and the fuel sprays 132a, 132b injected from the injection port group 130. The fifth embodiment has the substantially the same advantages as the fourth embodiment.

According to the fifth embodiment, the injection ports 111a, 111b, 111c, 131a, 131b correspond to “first injection ports” of the present invention.

### Sixth Embodiment

A sixth embodiment is a modification of the fifth embodiment. As shown in FIG. 13, arrangements of the injection ports 111a, 111b, 111c in the injection port group 110 and the injection ports 131a, 131b in the injection port group 130 are different from those in the fifth embodiment. A characteristic configuration different from the fifth embodiment will be described below.

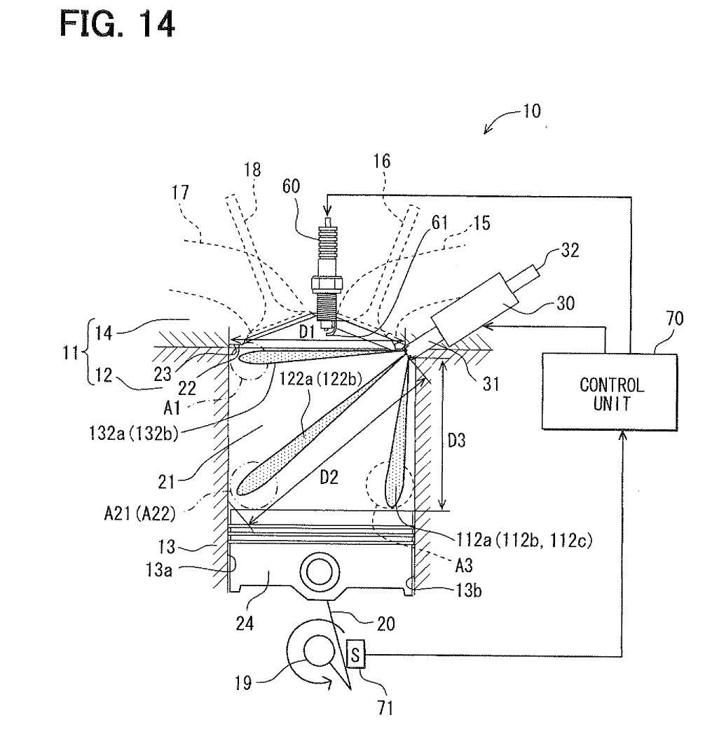

FIG. 13 shows an arrangement of seven injection ports 111a, 111b, 111c, 121a, 121b, 131a, 131b which are formed in the injection port member 42, viewed from interior. An arrangement of the injection port group 110 and the injection port group 130 are interchanged to each other with respect to the fifth embodiment. The injection port group 110 corresponds to the space “A3” and the injection port group 130 corresponds to the space “A1”. Thus, the fuel sprays 112a, 112b, 112c injected from the injection ports 111a, 111b, 111c interact with each other and reach the space “A3”. The fuel sprays 132a, 132b injected from the injection ports 131a, 131b interact with each other and reach the space “A1”, as shown in FIG. 14. The fuel sprays 122a, 122b injected from the injection ports 121a, 121b interact with each other and reach the space “A21” and the space “A22” respectively.

The distance “D3” from the injection portion 31 to the space “A3” and the distance “D1” from the injection portion 31 to the space “A1” are shorter than the distance “D2” from the injection portion 31 to the spaces “A21”, “A22”. Further, the distance “D3” is shorter than the distance “D1”. That is, the sixth embodiment is applied to a long-stroke engine 10 in which a stroke of the piston 24 is longer than an inner diameter of the cylinder 13. The fuel injector 30 according to the sixth embodiment is suitable for the long-stroke engine 10.

According to the sixth embodiment, the injection ports 111a, 111b, 111c, 131a, 131b correspond to “first injection ports” of the present invention. The space “A1” and the space “A3” corresponds to “first space” of the present invention.

### Seventh Embodiment

A seventh embodiment is a modification of the sixth embodiment. According to the seventh embodiment, a pair of the injection port groups 110 is provided instead of providing the injection port group 130. A characteristic configuration different from the sixth embodiment will be described below.

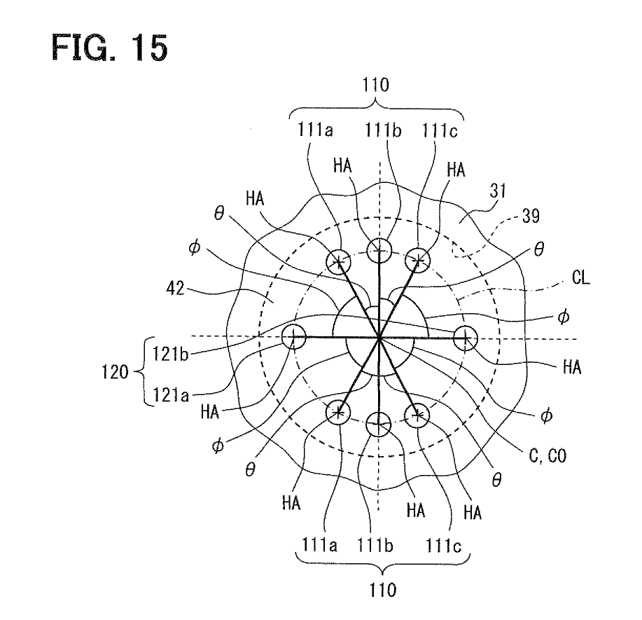

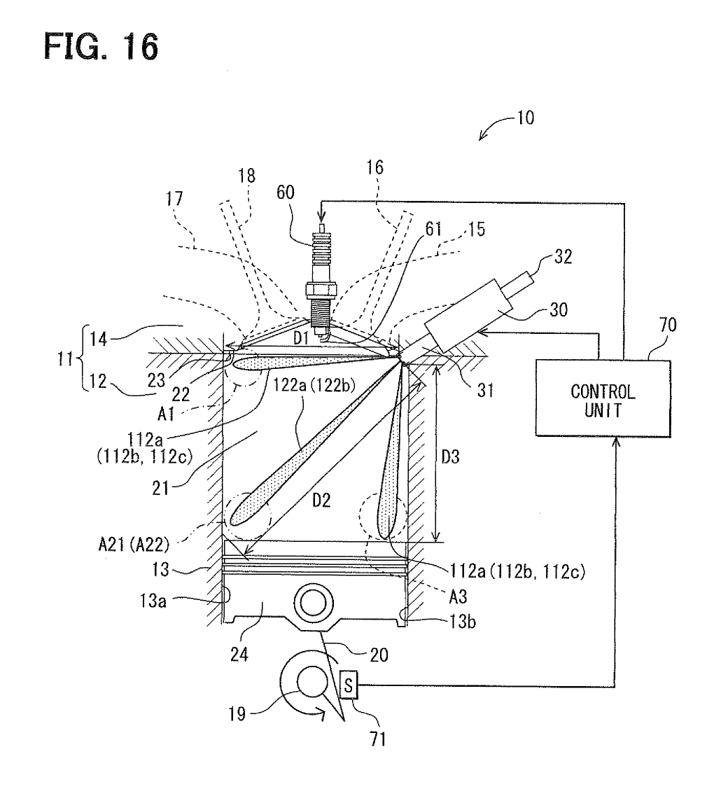

FIG. 15 shows a pair of the injection port groups 110 respectively comprised of the injection ports 111a, 111b, 111c and an injection port group 120 comprised of the injection ports 121a, 121b. The upper injection port group 110 in FIG. 15 corresponds to the space “A1”. The lower injection port group 110 corresponds to the third space “A3”. In the upper and the lower injection port group 110, the interspace angle θ between adjacent injection ports are the same as each other.

Thus, the fuel sprays 112a, 112b, 112c injected from the upper injection port group 110 interact with each other and reach the space “A1”. The fuel sprays 112a, 112b, 112c injected from the lower injection port group 110 interact with each other and reach the space “A3”.

In the seventh embodiment, the distance “D1” from the injection portion 31 to the space “A1” and the distance “D3” from the injection portion 31 to the space “A3” are equal to each other and are shorter than the distance “D2” from the injection portion 31 to the spaces “A21”, “A22”. That is, the seventh embodiment is applied to a square-stroke engine 10 in which a stroke of the piston 24 is substantially equal to an inner diameter of the cylinder 13. The fuel injector 30 according to the seventh embodiment is suitable for the square-stroke engine 10.

According to the seventh embodiment, the injection ports 111a, 111b, 111c of the upper injection port group 110 and the lower fuel injection port group 110 correspond to “first injection ports” of the present invention. The space “A1” and the space “A3” corresponds to “first space” of the present invention.

### Eighth Embodiment

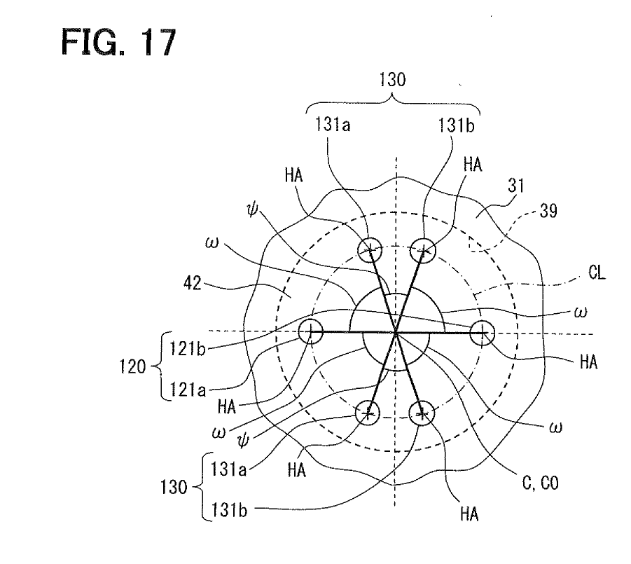

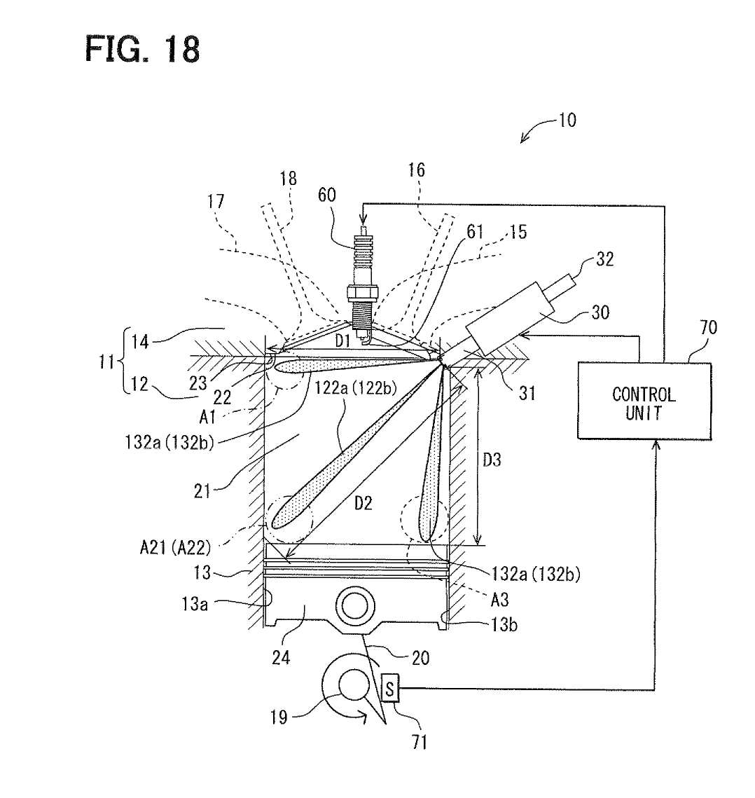

An eight embodiment is a modification of the fifth embodiment. According to the eighth embodiment shown in FIG. 17, an injection port group 130 comprised of the injection ports 131a, 131b is provided instead of the injection port group 110. A characteristic configuration different from the fifth embodiment will be described below.

FIG. 17 shows a pair of the injection port groups 130 comprised of the injection ports 131a, 131b and an injection port group 120 comprised of the injection ports 121a, 121b. The upper injection port group 130 in FIG. 17 corresponds to the space “A1”. In the upper and the lower injection port group 130, the interspace angle φ between adjacent injection ports 131a, 131b are the same as each other.

Thus, the fuel sprays 132a, 132b injected from the upper injection port group 130 interact with each other and reach the space “A1”. The fuel sprays 112a, 112b, 112c injected from the lower injection port group 130 interact with each other and reach the space “A3”.

In the eighth embodiment, the distance “D1” from the injection portion 31 to the space “A1” and the distance “D3” from the injection portion 31 to the space “A3” are equal to each other and are shorter than the distance “D2” from the injection portion 31 to the spaces “A21”, “A22”. The fuel injector 30 according to the eighth embodiment is suitable for the square-stroke engine 10.

According to the eighth embodiment, the injection ports 131a, 131b of the upper injection port group 130 and the lower injection port group 130 correspond to “first injection ports” of the present invention. The space “A1” and the space “A3” corresponds to “first space” of the present invention.

### Other Embodiment

The present invention should not be limited to the disclosure embodiment, but may be implemented in other ways without departing from the sprit of the invention.

Specifically, the number of injection ports of each injection port group 110, 120, 130 can be changed suitably. Further, in a case that three or more injection ports are provided in an injection port group, the interval of axes of adjacent injection ports can be different from each other.

What is claimed is:

1. A fuel injector for an internal combustion engine, the fuel injector directly injecting a fuel into a combustion chamber of the internal combustion engine, the fuel injector comprising:
a body portion defining a fuel passage through which the fuel flows toward its tip end, the body portion having a plurality of injection ports through which the fuel in the fuel passage is injected into the combustion chamber; and
a valve member accommodated slidably in the fuel passage for opening/closing the injection ports; wherein
the injection ports are arranged on a virtual circle around a center axis of the body portion,
the injection ports include at least two first injection ports of which injection-port axes extend toward a first space in the combustion chamber,
the injection ports include at least one second injection port of which injection-port axis extends toward a second space in the combustion chamber, and
a first interval of the injection-port axes between the first injection ports which are adjacent to each other on the virtual circle is shorter than a second interval of the injection-port axes between the first injection port and the second injection port which are adjacent to each other on the virtual circle.

2. A fuel injector according to claim 1, wherein
the first interval is defined by an interspace angle which is formed by the injection-port axes of the adjacent first injection ports around the center axis of the body portion within a range from 35° to 60°,
the second interval is defined by an interspace angle which is formed by the injection-port axes of the first injection port and the second injection port around the center axis of the body portion within a range over 60°, and
the second interval is longer than the first interval.

3. A fuel injector according to claim 1, wherein
the first interval is defined by an interspace angle which is formed by the injection-port axes of the adjacent first injection ports around the center axis of the body portion within a range from 35° to 60°,
the second interval is defined by an interspace angle which is formed by the injection-port axes of the first injection port and the second injection port around the center axis of the body portion within a range from 35° to 60°, and
the second interval is longer than the first interval.

4. A fuel injector according to claim 2, wherein
the first interval is defined by an interspace angle which is formed by the injection-port axes of the adjacent first injection ports around the center axis of the body portion within a range from 50° to 60°.

5. A fuel injector according to claim 1, wherein
the injection ports include at least two second injection port,
a third interval of the injection-port axes of adjacent second injection ports is longer than the first interval of the injection-port axes of the first injection ports.

6. A fuel injector according to claim 2, wherein
the injection ports include at least two second injection port,
a third interval of the injection-port axes between adjacent second injection ports on the virtual circle is defined by an interspace angle which is formed by the injection-port axes of the adjacent second injection ports around the center axis of the body portion within a range from 35° to 60°, and
the third interval is longer than the first interval.

7. A fuel injector according to claim 1, wherein
the first injection ports forms a plurality of first injection port groups, and
each of the injection-port axes of each first injection port group extends respective first space in the combustion chamber.

8. A fuel injector according to claim 7, wherein
the interval of injection-port axes between adjacent first injection ports in each first injection port group is equal to each other.
